(19) United States
(12) Patent Application Publication
(10) Pub. No.: US 2025/0317988 A1
(43) Pub. Date: Oct. 9, 2025

(54) TIMING CONSIDERATIONS FOR TRANSMISSION OCCASIONS IN FULL DUPLEX

(71) Applicant: QUALCOMM Incorporated, San Diego, CA (US)

(72) Inventors: Abdelrahman Mohamed IBRAHIM, San Diego, CA (US); Muhammad Sayed Khairy ABDELGHAFFAR, San Jose, CA (US); Ahmed Attia ABOTABL, San Diego, CA (US)

(21) Appl. No.: 19/095,687

(22) Filed: Mar. 31, 2025

Related U.S. Application Data
(60) Provisional application No. 63/573,881, filed on Apr. 3, 2024.

(51) Int. Cl. H04W 74/0833; H04L 5/14; H04W 56/00

(52) U.S. Cl. CPC H04W 74/0833; H04L 5/14; H04W 56/001

(57) ABSTRACT

Methods, systems, and devices for wireless communication are described. A user equipment (UE) may receive a control message indicating full duplex resources for one or more random access messages of a random access procedure associated with one or more transmission occasions. The UE may perform a validation procedure to determine a validity of a transmission occasion based on a gap and a relative placement of a synchronization message. In some examples, the transmission occasion may be considered valid even if the gap is less than a threshold time gap and even if the transmission occasion precedes the synchronization message. Based on the validity, the UE may receive the synchronization message, transmit a random access message on the transmission occasion, or both. If a collision occurs between the transmission occasion and the synchronization message, the UE may apply one or more collision handling rules.

### CROSS REFERENCE

The present Application for Patent claims the benefit of U.S. Patent Application No. 63/573,881 by Ibrahim et al., entitled “TIMING CONSIDERATIONS FOR TRANSMISSION OCCASIONS IN FULL DUPLEX,” filed Apr. 3, 2024, which is assigned to the assignee hereof and is expressly incorporated by reference herein.

### FIELD OF TECHNOLOGY

The following relates to wireless communication, including timing considerations for transmission occasions in full duplex.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support timing considerations for transmission occasions in full duplex. For example, the described techniques provide for varying definitions for valid transmission occasions, such as for random access occasions (ROs) or physical uplink shared channel (PUSCH) occasions (POs), and timing considerations in full duplex communications, including sub-band full duplex (SBFD). For example, a network may allow a transmission occasion to preceded one or more synchronization messages (e.g., synchronization signal (SS)/physical broadcast channel (PBCH) blocks (SSBs)), or may allow transmission occasions and synchronization messages to be within a quantity of symbols smaller than an N_{g} gap in symbols for non-SSB-aware user equipments (UEs), or to even be adjacent or overlap. In some examples, transmission occasions and synchronization messages may involve various combinations of separation and placement (e.g., preceding) rules in SBFD-DL symbols and flexible-link (FL) symbols. Transmission occasions and synchronization messages may further involve collision handling rules and additional rules when there is overlap.

A method for wireless communication by a UE is described. The method may include receiving a control message indicating resources allocated for one or more random access messages associated with a random access procedure, the resources including full duplex resources corresponding to one or more transmission occasions of the random access procedure, receiving, during a first time duration, a synchronization message, and transmitting, during a second time duration different from the first time duration, a random access message associated with the random access procedure based on a validity of a transmission occasion, of the one or more transmission occasions, that corresponds to the second time duration, where the validity of the transmission occasion is based on a relationship between the first time duration and the second time duration.

A UE for wireless communication is described. The UE may include one or more memories storing processor executable code, and one or more processors coupled with the one or more memories. The one or more processors may individually or collectively be operable to execute the code to cause the UE to receive a control message indicating resources allocated for one or more random access messages associated with a random access procedure, the resources including full duplex resources corresponding to one or more transmission occasions of the random access procedure, receive, during a first time duration, a synchronization message, and transmit, during a second time duration different from the first time duration, a random access message associated with the random access procedure based on a validity of a transmission occasion, of the one or more transmission occasions, that corresponds to the second time duration, where the validity of the transmission occasion is based on a relationship between the first time duration and the second time duration.

Another UE for wireless communication is described. The UE may include means for receiving a control message indicating resources allocated for one or more random access messages associated with a random access procedure, the resources including full duplex resources corresponding to one or more transmission occasions of the random access procedure, means for receiving, during a first time duration, a synchronization message, and means for transmitting, during a second time duration different from the first time duration, a random access message associated with the random access procedure based on a validity of a transmission occasion, of the one or more transmission occasions, that corresponds to the second time duration, where the validity of the transmission occasion is based on a relationship between the first time duration and the second time duration.

A non-transitory computer-readable medium storing code for wireless communication is described. The code may include instructions executable by one or more processors to receive a control message indicating resources allocated for one or more random access messages associated with a random access procedure, the resources including full duplex resources corresponding to one or more transmission occasions of the random access procedure, receive, during a first time duration, a synchronization message, and transmit, during a second time duration different from the first time duration, a random access message associated with the random access procedure based on a validity of a transmission occasion, of the one or more transmission occasions, that corresponds to the second time duration, where the validity of the transmission occasion is based on a relationship between the first time duration and the second time duration.

Some examples of the method, UE, and non-transitory computer-readable medium described herein may further include operations, features, means, or instructions for performing a validation procedure to determine that the transmission occasion is valid based on one or more symbols of the second time duration preceding one or more symbols of the first time duration.

In some examples of the method, UE, and non-transitory computer-readable medium described herein, one or more symbols of the second time duration are within a same slot in the time domain as one or more symbols of the first time duration.

Some examples of the method, UE, and non-transitory computer-readable medium described herein may further include operations, features, means, or instructions for performing a validation procedure to determine that the transmission occasion is valid based on a gap between the first time duration and the second time duration satisfying a first threshold time gap.

Some examples of the method, UE, and non-transitory computer-readable medium described herein may further include operations, features, means, or instructions for performing a validation procedure to determine that the transmission occasion is valid based on one or more symbols of the first time duration preceding one or more symbols of the second time duration and a gap between the first time duration and the second time duration satisfying a threshold time gap associated with a second random access procedure.

Some examples of the method, UE, and non-transitory computer-readable medium described herein may further include operations, features, means, or instructions for receiving, during a third time duration different from a fourth time duration corresponding to a second transmission occasion, a second synchronization message based on one or more symbols of the third time duration overlapping with one or more symbols of the fourth time duration and transmitting, during the fourth time duration corresponding to the second transmission occasion, a second random access message associated with a second random access procedure based on the overlap.

In some examples of the method, UE, and non-transitory computer-readable medium described herein, receiving the second synchronization message or transmitting the second random access message may include operations, features, means, or instructions for receiving the second synchronization message based on the second synchronization message having a higher priority than the second transmission occasion, on performing one or more measurements for the second synchronization message, or on an index associated with the second synchronization message having a higher priority than one or more additional indexes and transmitting the second random access message based on the second random access message and the second transmission occasion having a higher priority than the second synchronization message, on an occurrence of a random access triggering event, on the random access triggering event having a higher priority than one or more additional random access triggering events, or on the index associated with the second synchronization message having lower priority than the one or more additional indexes.

In some examples of the method, UE, and non-transitory computer-readable medium described herein may further include operations, features, means, or instructions for performing a validation procedure to determine that the transmission occasion is valid based on one or more symbols of the first time duration not overlapping with one or more symbols of the second time duration. In some examples of the method, UE, and non-transitory computer-readable medium described herein, one or more symbols of the first time duration overlap with one or more symbols of the second time duration.

In some examples of the method, UE, and non-transitory computer-readable medium described herein, the synchronization message, the random access message, and the transmission occasion may be associated with a threshold frequency gap, two or more different beams, a threshold time gap for messages of a same index, and a minimum transmission power for random access messages, or any combination thereof.

In some examples of the method, UE, and non-transitory computer-readable medium described herein, the UE may be in a connected mode or an idle mode.

In some examples of the method, UE, and non-transitory computer-readable medium described herein, the transmission occasion includes one or more uplink symbols or one or more flexible symbols in an uplink frequency sub-band. In some examples, the one or more uplink symbols and the one or more flexible symbols may include SBFD symbols (e.g., at least one or more symbols of the transmission occasion are uplink symbols or flexible symbols in an uplink frequency sub-band, the transmission occasion is at least partially within SBFD symbols).

In some examples of the method, UE, and non-transitory computer-readable medium described herein, the transmission occasion includes an RO and the random access procedure includes a 4 step random access procedure.

In some examples of the method, UE, and non-transitory computer-readable medium described herein, the transmission occasion includes a PO and the random access procedure includes a 4 step random access procedure or a 2 step random access procedure.

### BRIEF DESCRIPTION OF THE DRAWINGS

FIG. 1 shows an example of a wireless communications system that supports timing considerations for transmission occasions in full duplex in accordance with one or more aspects of the present disclosure.

FIGS. 2A and 2B show examples of a wireless communications system and a timing diagram that supports timing considerations for transmission occasions in full duplex in accordance with one or more aspects of the present disclosure.

FIGS. 3A and 3B show examples of timing diagrams that support timing considerations for transmission occasions in full duplex in accordance with one or more aspects of the present disclosure.

FIG. 4A and 4B show examples of timing diagrams that supports timing considerations for transmission occasions in full duplex in accordance with one or more aspects of the present disclosure.

FIG. 5 shows an example of a process flow that supports timing considerations for transmission occasions in full duplex in accordance with one or more aspects of the present disclosure.

FIGS. 6 and 7 show block diagrams of devices that support timing considerations for transmission occasions in full duplex in accordance with one or more aspects of the present disclosure.

FIG. 8 shows a block diagram of a communications manager that supports timing considerations for transmission occasions in full duplex in accordance with one or more aspects of the present disclosure.

FIG. 9 shows a diagram of a system including a device that supports timing considerations for transmission occasions in full duplex in accordance with one or more aspects of the present disclosure.

FIGS. 10 through 12 show flowcharts illustrating methods that support timing considerations for transmission occasions in full duplex in accordance with one or more aspects of the present disclosure.

### DETAILED DESCRIPTION

A network may support full duplex operations at one or more devices. For example, a network may support sub-band full duplex (SBFD) operations, where a band may be split into one or more sub-bands for uplink (UL) communications and one or more sub-bands for downlink (DL) communications. In SBFD, a network entity may communicate with multiple user equipments (UEs) in both UL and DL simultaneously, while some UEs may support half-duplex operation involving communicating in one of UL or DL at a same time. A network may further configure one or more UEs with multiple transmission occasions for a random access channel (RACH) procedure, such as a physical RACH (PRACH) procedure. For example, in 4-step RACH, a network entity may indicate one or more RACH (e.g., PRACH) occasions (ROs) for transmission of a Msg1, while in 4-step and 2-step RACH, a network entity may indicate one or more physical uplink shared channel (PUSCH) occasions (POs) for transmission of a Msg3 or MsgA, respectively. An RO or PO may be considered valid if the occasion does not precede a synchronization signal (SS)/physical broadcast channel (PBCH) block (SSB), and if the occasion starts at least N_{g} (e.g., an N_{g} symbol gap, N_{gap}) symbols after a last reception symbol of the SSB. However, RO and PO validity may not yet be defined for SBFD communications, and thus may present opportunities to define new validation rules.

Techniques described herein support further improvements in communications by defining valid transmission occasions (e.g., ROs and POs) and timing considerations in full duplex (e.g., SBFD) communications. In some cases, conditions regarding transmission occasion timing (e.g., location) relative to SSBs may be relaxed. For example, a network may allow an RO/PO to precede an SSB, or may allow ROs/POs and SSBs to be within a quantity of symbols smaller than a value of Ng for non-SSB-aware UEs or to be adjacent or overlap. Relaxing such rules may thus provide a more flexible timing structure, which may enable increased efficiency in resource usage of a network as well as reduce latency in communications. In some examples, ROs/POs and SSBs in SBFD symbols may involve any combination of separation and placement (e.g., preceding) rules in SBFD-DL symbols, and in some cases may involve an N_{g} symbol gap separation and ROs/POs following SSBs for flexible-link (FL) symbols. In some examples, as described herein, an RO or PO may in some examples be considered valid if the occasion starts at least N_{g} (e.g., N_{gap}) symbols after a last reception symbol of an SSB. SBFD communications may in some cases involve a minimum frequency gap, use of separate beams for UL and DL communications, a minimum gap between SSBs and ROs/POs of a same index, and a maximum transmit power on an RO/PO. Collision handling in SBFD may in some cases involve either transmitting a RACH message on an RO/PO or receiving an overlapping SSB based on a UE implementation, a priority of SSBs or ROs/POs, a type of RACH triggering event, or an SSB index.

Aspects of the disclosure are initially described in the context of wireless communications systems. Aspects of the disclosure are further illustrated by and described with reference to wireless communications systems, timing diagrams, and process flows that relate to timing considerations for transmission occasions in full duplex. Aspects of the disclosure are further illustrated by and described with reference to apparatus diagrams, system diagrams, and flowcharts that relate to timing considerations for transmission occasions in full duplex.

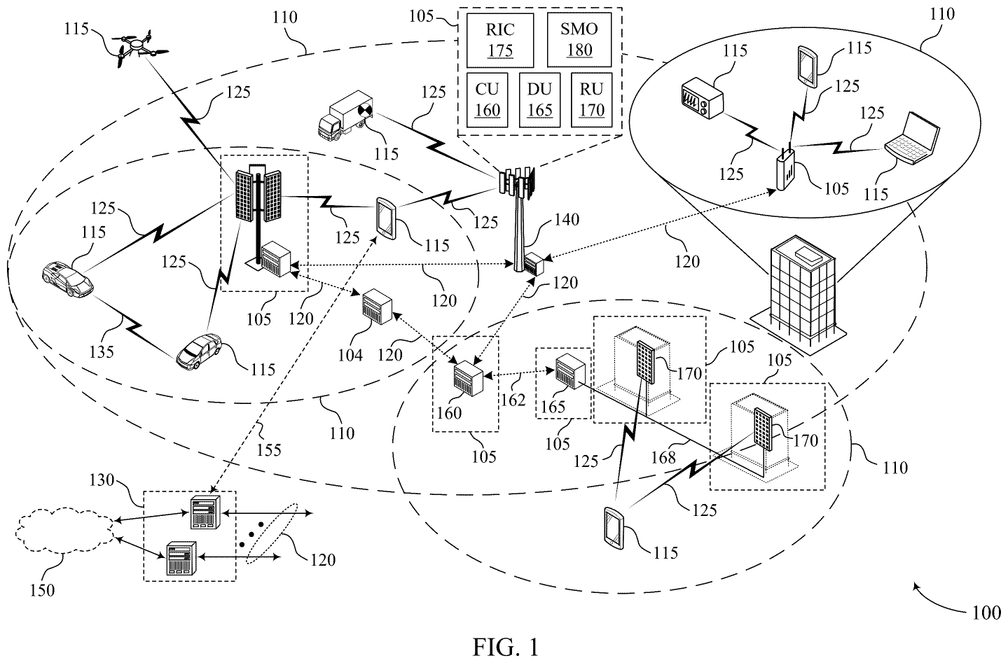

FIG. 1 shows an example of a wireless communications system 100 that supports timing considerations for transmission occasions in full duplex in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple DL component carriers and one or more UL component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include DL transmissions (e.g., forward link transmissions) from a network entity 105 to a UE 115, UL transmissions (e.g., return link transmissions) from a UE 115 to a network entity 105, or both, among other configurations of transmissions. Carriers may carry DL or UL communications (e.g., in an FDD mode) or may be configured to carry DL and UL communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of T_{S}=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a DL carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include DL transmissions, UL transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Techniques described herein support further improvements in communications by defining valid transmission occasions (e.g., ROs and POs) and timing considerations in full duplex (e.g., SBFD) communications. For example, communications in the wireless communications system 100 may allow an RO/PO to precede an SSB, or may allow ROs/POs and SSBs to be within a quantity of symbols smaller than a value of N_{g} for non-SSB-aware UEs or to be adjacent or overlap. Relaxing such rules may thus provide a more flexible timing structure, which may enable increased efficiency in resource usage of a network. In some examples, ROs/POs and SSBs in SBFD symbols may involve any combination of separation and preceding rules in SBFD-DL symbols, and in some cases may involve an N_{g} symbol gap separation and ROs/POs following SSBs for FL symbols. In some examples, as described herein, an RO or PO may in some examples be considered valid if the occasion starts at least N_{g} (e.g., N_{gap}) symbols after a last reception symbol of an SSB. SBFD communications may in some cases involve a minimum frequency gap, use of separate beams for UL and DL communications, a minimum gap between SSBs and ROs/POs of a same index, and a maximum transmit power on an RO/PO. Collision handling in SBFD may in some cases involve either transmitting a RACH message on an RO/PO or receiving an overlapping SSB based on a UE implementation, a priority of SSBs or ROs/POs, a type of RACH triggering event, or an SSB index.

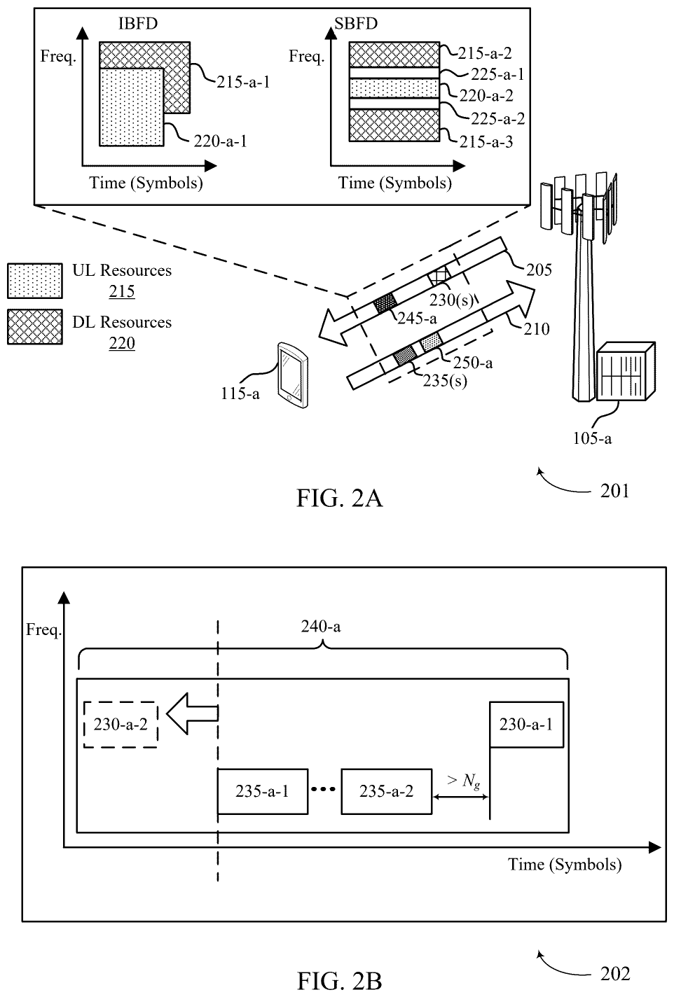

FIG. 2A shows an example of a wireless communications system 201 and FIG. 2B shows an example of a timing diagram 202 that support timing considerations for transmission occasions in full duplex in accordance with one or more aspects of the present disclosure. In some examples, the wireless communications system 201 and the timing diagram 202 may implement or be implemented by aspects of the wireless communications system 100. For example, the wireless communications system 201 may illustrate a network entity 105, such as a network entity 105-a, that may be in communication with one or more UEs 115, such as with a UE 115-a. The UE 115-a may include a DL communication link 205 and an UL communication link 210 with the network entity 105-a. In some cases, the UE 115-a and the network entity 105-a may support definitions for valid transmission occasions and timing considerations in full duplex communications.

For example, the wireless communications system 201 may support full duplex and half-duplex communications. In some examples, full duplex communications may enable a device, such as the network entity 105-a, to transmit and receive at a same time using DL resources 215 and UL resources 220, while half-duplex communications may enable a device, such as the UE 115-a, to either transmit over UL resources 220, or receive over one or more DL resources 215, at a given time. The wireless communications system 201 (e.g., the wireless communications system 201, devices of the wireless communications system 201, UEs 115 of the wireless communications system 201, network entities 105 of the wireless communications system 201, among other examples) may support different types of full duplex configurations, including in-band full duplex (IBFD), SBFD, among other types of full duplex communication.

IBFD communications may involve transmitting and receiving on a same time and frequency resource, where UL and DL communications may share one or more same IBFD time resources, IBFD frequency resources, or both. For example, DL resources 215-a-1 and UL resources 220-a-1 may partially or fully overlap one or more symbols and frequencies. SBFD communications (e.g., sub-band FDD, flexible duplex) may involve transmitting and receiving at a same time (e.g., during one or more same symbols or slots) but on different frequency resources. For example, in an SBFD configuration, non-overlapping UL and DL sub-bands (e.g., component carriers) may be configured so that DL resources 215-a-2 may be separated from UL resources 220-a-2 and 220-a-3 in the frequency domain. In some cases, a guard band 225, such as guard bands 225-a-1 and 225-a-2, may be included between DL resources 215 and UL resources 220 in SBFD to protect communications from interference. Further, although not shown, the wireless communications system 201 may include additional network entities 105 supporting full duplex (e.g., FD network entities, FD gNBs, IBFD/SBFD TDD gNBs) and UEs 115 supporting either half-duplex (e.g., HD UEs) or full duplex (e.g., FD UEs, IBFD/SBFD aware UEs) and may include multiple TRP (multi-TRP) communications. In some examples, full duplex UEs 115, may experience self-interference while P2P communications between UEs 115 or backhaul communications between network entities may experience cross-link interference (CLI) from other UL or DL communications of the wireless communications system 201.

In some cases, for a RACH operation for SBFD-aware UEs (e.g., in RRC-CONNECTED state) (or IBFD-aware UEs, or IBFD-aware and SBFD-aware UEs), one or more configurations may be considered to define a valid RO/PO (e.g., to define one or more RO/PO validation rules). For example, multiple configurations may be defined for unpaired spectrum and for SSBs with indexes provided by ssb-PositionsInBurst in SIB1 or by ServingCellConfigCommon. In some cases, the network entity 105-a may configure one or more UEs 115 using a single RACH configuration (e.g., the UEs 115 are provided tdd-UL-DL-ConfigurationCommon), where ROs within an UL sub-band (UL-SB) in SBFD symbols may be considered valid for SBFD-aware UEs (e.g., the UE 115-a). Additionally, or alternatively, the network entity 105-a may configure one or more UEs 115 using two separate RACH configurations (e.g., the UEs 115 are not provided tdd-UL-DL-ConfigurationCommon), including a first RACH configuration for non-SBFD-aware UEs 115 (e.g., for TDD RACH) and a second RACH configuration for SBFD-aware UEs (e.g., for SBFD RACH). In the second configuration, ROs/POs within an UL-SB in SBFD symbols may be considered valid for SBFD-aware UEs.

In some examples, using a single RACH configuration for all symbol types (e.g., SBFD symbols, DL symbols, FL symbols) may reduce signaling and overhead (or extra configurations) in the wireless communications system 201 while allowing non-SBFD-aware UEs 115 to leverage RACH in SBFD symbols, for example, if one or more ROs or POs are configured in SBFD FL symbols (as non-SBFD-aware UEs may not support UL transmissions in DL slots even if those DL slots include an UL sub-band for SBFD). Further, a single configuration may involve indications of SBFD-ROs or SBFD-POs, and may define RO/PO validity rules in SBFD-DL symbols (e.g., by TDD-DL-UL) and may include SSB-RO/PO mapping. In some examples, separate RACH configurations for each duplex types (e.g., RO-Confg1 for TDD and RO-Config2 for SBFD) may allow each RACH configurations to have separate parameters (e.g., RO/PO time and frequency resources, power configurations) while allowing independent SSB-RO/PO mapping and less ambiguity between non-SBFD-aware UEs and SBFD-aware UEs. Separate configurations may involve RO/PO validity rules for SBFD-aware UEs to be defined in SBFD-DL symbols by TDD-DL-UL, and may involve SBFD-aware UE selection of ROs/POs configuration as well as switching between RO/PO-configurations.

In some examples, the wireless communications system 201 may support different RACH types, including 2-step RACH, 4-step RACH, or both. In 4-Step RACH, a UE 115 and network entity 105 may exchange a Msg1 (e.g., random access preamble on PRACH), Msg2 (e.g., random access response (RAR) on a physical downlink shared channel (PDSCH)), Msg3 (e.g., scheduled transmission on PUSCH), and Msg4 (e.g., contention resolution on PDSCH). By way of another example, 2-Step RACH may involve communication of a MsgA (e.g., preamble and data, Msg1+Msg3) and a MsgB (e.g., RAR and contention resolution, Msg2+Msg4). In some cases, using 2-Step RACH may reduce a latency and signal overhead compared to 4-Step RACH, and may support timing advance (TA)-free and grant-free small UL packet transmission with different transport block sizes and multiplexing coding schemes. Further, 2-step RACH may improve a capacity and power efficiency compared to 4-Step contention-based RACH (CBRA) and may replace RACH-less handover. 4-Step RACH may in some cases have less performance degradation compared to 2-Step RACH (e.g., as 2-Step may have no TA) as well as less PUSCH resource waste. Further, different RACH types may involve a trade-off between collision probability (e.g., of the PUSCH part of MsgA) and resource overhead (e.g., one to one mapping or many to one mapping of a preamble to PUSCH).

In some examples, RO/PO validation in SBFD (e.g., in SBFD-FL and SBFD-DL symbols or slots) may be based on one or more separation or placement parameters. In some examples, a configured RO/PO in an FL symbol may be considered valid if the RO/PO does not precede an SSB in a PRACH slot and starts at least N_{g} (e.g., N_{gap}) symbols after a last SSB reception symbol. For example, the UE 115-a may be configured by the network entity 105-a with one or more transmission occasions 230 in one or more SBFD symbols of a slot 240-a (e.g., a RACH slot, a PRACH slot), where transmission occasions 230 may be examples of candidate ROs or POs for one or more RACH procedures. During a RACH procedure, the UE 115-a may determine that the transmission occasion 230-a-1 is valid as the transmission occasion does not precede a last symbol of the synchronization message 235-a-2, while the UE 115-a may determine that a transmission occasion 230-a-2 is invalid as the transmission occasion may precede the synchronization message 235-a-1. Further, the UE 115-a may determine that the transmission occasion 230-a-1 is valid as the transmission occasion may be at least N_{g} symbols (e.g., ≥N_{g}) after the last symbol of the synchronization message 235-a-2 (e.g., after a latest SSB). In some examples one or more values of N_{g} may correspond to different preamble SCS values. Further, one or more candidate indexes may be provided for one or more SSBs. For example, a candidate SSB index of an SSB may correspond to an SSB index provided by a parameter ssb-PositionsInBurst in an SIB1 message or in a parameter ServingCellConfigCommon. In some cases, if channelAccessMode=“semiStatic” is provided, ROs/POs may not overlap with a set of consecutive symbols before the start of a next channel occupancy time where a UE 115 does not transmit.

Defining a symbol gap N_{g} for valid ROs/POs and preventing ROs/POs from preceding SSBs may thus protect a RACH procedure (e.g., in TDD) from interference from one or more SSBs (e.g., may protect PRACH other cell(s) SSB transmissions) and vice versa. However, although rules for valid ROs/TOs may be defined for one or more RACH procedures (e.g., in TDD), some networks may lack definitions for valid occasions with respect to SBFD communications.

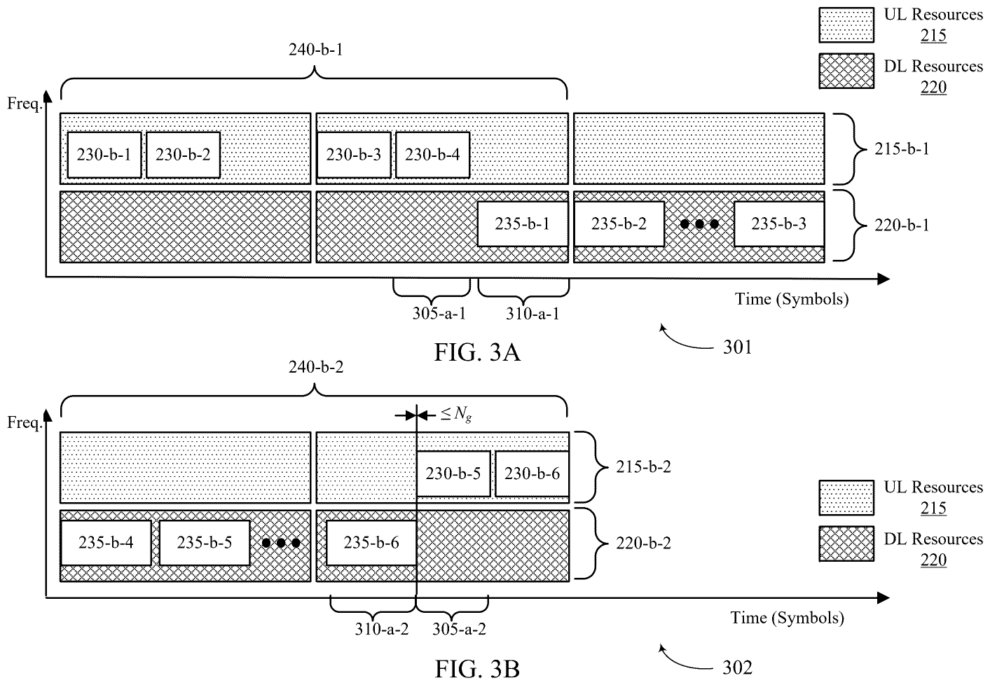

As described herein, the wireless communications system 201 may support different validation rules in SBFD for transmission occasions (e.g., ROs and POs). For example, the UE 115-a may receive a control message 245-a from the network entity 105-a for receiving one or more synchronization messages 235, where the control message 245-a may indicate a configuration for one or more transmission occasions 230 for transmitting random access messages 250, such as a random access message 250-a. Using one or more rules for SBFD communications (e.g., preconfigured at the UE 115-a or indicated in the control message 245-a or another message), the UE 115-a may determine one or more valid transmission occasions 230, and may receive one or more synchronization messages 235 and transmit one or more random access messages 250 accordingly. In some cases, time domain restrictions in SBFD may be considered in addition to frequency domain validation rules (e.g., ROs within UL sub-band) as described with respect to FIGS. 3A-5. For example, validation of ROs/POs may be based on conditions of RACH (e.g., PRACH) transmission (and corresponding ROs/POs) preceding or not preceding SSBs, an N_{g} symbol gap when SSBs precede RACH transmissions, and whether one or more conditions for other RACH procedures apply to SBFD in DL vs. FL slots. Further, collision handling rules between SSBs and valid ROs may be considered. In some examples, as described herein, an RO or PO may in some examples be considered valid if the occasion starts at least N_{g} (e.g., N_{gap}) symbols after a last reception symbol of an SSB.

FIGS. 3A and 3B show examples of a timing diagram 301 and a timing diagram 302, respectively, that support timing considerations for transmission occasions in full duplex in accordance with one or more aspects of the present disclosure. In some examples, the timing diagrams 301 and 302 may implement or be implemented by aspects of the wireless communications systems 100 and 201 and the timing diagram 202. For example, the timing diagrams 301 and 302 may illustrate timing of messaging between an SBFD-aware UE 115 and a network entity 105 supporting SBFD communications. In some cases, the timing diagrams 301 and 302 may illustrate relaxing one or more validation rules for determining valid transmission occasions 230.

In some examples, a condition of RACH procedures (e.g., PRACH transmissions and corresponding POs/ROs) not preceding SSB may be relaxed, where one or more configured ROs or POs in SBFD-FL (or SBFD-DL) symbols may be considered valid even if preceding SSB in a PRACH slot. For example, with respect to FIG. 3A, transmission occasions 230-b (e.g., ROs or POs), including transmission occasions 230-b-1, 230-b-2, 230-b-3, and 230-b-4, may be configured in UL resources 215-b-1 and may precede one or more synchronization messages 235 (e.g., one or more SSBs of an SSB burst), including synchronization messages 235-b-1, 235-b-2, through 235-b-3 received in one or more DL resources 220-b-1. The transmission occasions 230-b-1 through 230-b-4 may also be in a same slot 240-b-1 (e.g., a RACH slot, a PRACH slot) as the synchronization message 235-b-1. In some cases, each transmission occasion 230 may include a duration 305 of symbols, such as a duration 305-a-1, that may include one or more symbols preceding a duration 310-a-2 during which a synchronization message 235 is received. By thus relaxing this condition, for example, many ROs or POs in a PRACH slot may precede an SSB burst and be considered valid to efficiently use one or more UL resources.

In some examples, a condition of a symbol gap N_{g} when an SSB precedes one or more RACH procedures may be relaxed or kept, where a configured RO/PO in SBFD-FL (or SBFD-DL) symbols may be considered valid if starting any quantity of symbols after a last SSB reception symbol. In some examples, with respect to FIG. 3B, transmission occasions 230-b-5 and 230-b-6 may follow synchronization messages 235-b-4, 235-b-5, through 235-b-6, where a first symbol of the transmission occasion 230-b-5 (the occasion of a duration 305-a-2) may be less than N_{g} symbols after a last symbol of the synchronization message 235-b-6 (the message of a duration 310-a-2), or may be equal to N_{g} symbols after the last symbol of the synchronization message 235-b-6. The transmission occasion symbols may be adjacent to the synchronization message symbols, or may be in a closer proximity than N_{g} within a same slot 240-b-2 (or different slot). In some cases, RACH reception in UL-SB may experience interference of other cells with any value of N_{g} and may involve a one or more symbol DL-UL switching gap at a UE 115 (e.g., 1 symbol switching gap, multiple symbol switching gap). An RO/PO may in some examples be invalid if a gap between the RO/PO and an SSB (e.g., a gap between the transmission occasion 230-b-5 and the synchronization message 235-b-6) is less than a DL-UL switching gap configured at a UE (e.g., has less symbols than a one or more symbol DL-UL switching gap). Further, Ng (e.g., which may be larger than the gap between ROs/POs and SSBs) may in some cases include more symbols than a DL-UL switching gap (e.g., more than a 1 symbol DL-UL switching gap). By thus relaxing conditions related to N_{g}, for example, many a latency in communications may be reduced while providing a more flexible timing structure. Additionally, or alternatively, an RO or PO may be considered valid based on relaxing both separation rules (e.g., N_{g}) and preceding rules. For example, a last symbol of the transmission occasion 230-b-4 may precede a first symbol of the synchronization message 235-b-1 by less than N_{g} symbols.

Additionally, or alternatively, one or more conditions (e.g., rules) for valid transmission occasions may be the same for RACH in SBFD communications as one or more other RACH processes and configurations (e.g., no conditions are relaxed). For example, ROs/POs in SBFD-DL symbols may be considered valid if separated by N_{g} and if preceding SSBs in UL-SB. Further, ROs/POs in SBFD-FL symbols may be considered valid if separated by N_{g} and if preceding SSBs in UL-SB. Defining ROs and POs as satisfying restrictions used for non-SBFD-aware UEs 115 (e.g., Ng separation and ROs/POs preceding SSBs) may ensure corresponding RO-SSB mapping for non-SBFD-aware UEs 115 that may support communications in FL symbols. Further, one or more rules for RO (or PO) location relative to SSB may be relaxed regarding different modes while in UL-SB. For example, an Ng symbol gap and a preceding rule may be relaxed for one or more of idle mode (e.g., RRC_IDLE mode) and connected mode (e.g., RRC_CONNECTED mode). In some cases, a condition may be kept for idle mode or connected mode (e.g., keep N_{g} symbol gap in RRC_IDLE mode). In some examples, an RO or PO may be considered valid if the occasion starts at least Ng (e.g., N_{gap}) symbols after a last reception symbol of an SSB.

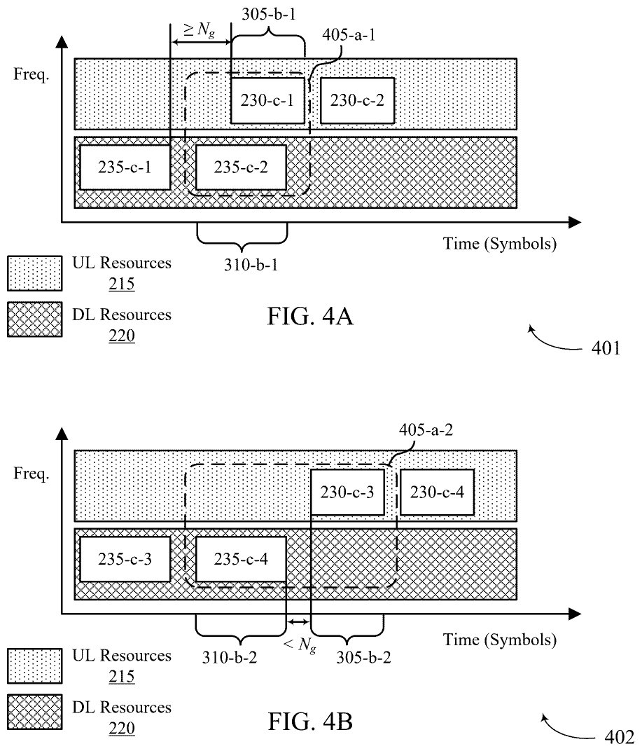

FIGS. 4A and 4B show examples of a timing diagram 401 and a timing diagram 402, respectively, that support timing considerations for transmission occasions in full duplex in accordance with one or more aspects of the present disclosure. In some examples, the timing diagrams 401 and 402 may implement or be implemented by aspects of the wireless communications systems 100 and 201 and the timing diagrams 202, 301, and 302. For example, the timing diagrams 401 and 402 may illustrate timing of messaging between an SBFD-aware UE 115 and a network entity 105 supporting SBFD communications. In some cases, the timing diagrams 401 and 402 may illustrate overlap allowed in a validation procedure.

For example, if a symbol gap N_{g} is relaxed as described with respect to FIGS. 3A and 3B, one or more ROs or POs may overlap in time with one or more SSBs. For example, a quantity of symbols less than N_{g} may be small enough that a collision in time is determined between one or more ROs and POs and SSBs. In some cases, a collision may be defined as an RO or PO and SSB overlapping in one or more symbols in time as illustrated in FIG. 4A. For example, one or more symbols of a duration 305-b-1 corresponding to a transmission occasion 230-c-1 (before a transmission occasion 230-c-2) may overlap with one or more symbols of a duration 310-b-1 in which a synchronization message 235-c-2 (following a synchronization message 235-c-1) is received. The overlap in FIG. 4A may represent a collision 405, such as a collision 405-a-1.

Additionally, or alternatively, a collision in time may be defined as an RO or PO and SSB having less than an N_{g} symbol separation in time, where an N_{g} symbol gap may be the same or different than N_{g} for one or more other RACH processes or communications (e.g., TDD). For example, one or more symbols of a duration 305-b-2 corresponding to a transmission occasion 230-c-3 (before a transmission occasion 230-c-4) may overlap with one or more symbols of a duration 310-b-2 in which a synchronization message 235-c-4 (following a synchronization message 235-c-3) is received, where the overlap in FIG. 4B may represent a collision 405-a-2.

One or more rules or parameters may be defined to protect SSBs and to ensure proper reception of one or more RACH messages via ROs or POs. In some cases, a minimum frequency gap (e.g., a guard band 225) between time overlapping ROs/POs and SSBs may be defined (e.g., interference to protect SSB). For example, a minimum frequency separation may be defined between an overlapping transmission occasion 230 and synchronization message 235. In some cases, overlap may be allowed based on correlation between ROs and SSBs. For example, overlap between signals of different indexes may be allowed, where the transmission occasion 230-c-1 may be an RO0 (e.g., of index 0), while the synchronization message 235-c-1 may be an SSB0 of a same index and the overlapping synchronization message 235-c-2 may be an SSB1 (e.g., of index 1). In some cases, overlap between signals (e.g., between ROs and SSBs) may not be allowed. In some examples, for a network entity 105 (e.g., gNB) to transmit SSBs and receive RACH messages during ROs/POs simultaneously, an SSB transmission beam may be assumed or defined for SSBs and ROs/POs. For example, an RO0 receive beam may be different than an SSB1 transmit beam to reduce leakage the network entity 105. A one or more symbol DL-UL switching gap may also be defined, where ROs/POs may be valid if separated from SSBs by at least a same quantity of symbols as the DL-UL switching gap. For example, a UE 115 may determine to receive one or more SSBs, transmit one or more random access messages, or both, as long as a switching gap value is satisfied by each corresponding gap between a transmission occasion 230 and a synchronization message 235.

A minimum time gap may also be defined for SSBs and ROs or POs of a same index. In some cases, a time gap may be used for an RO and an associated SSB (e.g., of a same index with 1-to-1 mapping between SSB and RO). For example, the transmission occasion 230-c-3, such as an RO0, and may be considered valid if separated from the synchronization message 235-c-1, such as an SSB0. Additionally, or alternatively, a maximum power may be defined for RACH transmissions (e.g., for a random access message 250) on an RO or PO that overlaps in time with an SSB to reduce the CLI. For example, a maximum power limitation for an RO0 may be lower than an RO1.

Collision handling rules may also be defined between SSB and valid ROs, for example, when a collision is detected. For example, if an SSB overlaps in time with a valid RO (e.g., according to collision definitions of FIG. 4A or FIG. 4B), a half-duplex UE 115 may determine to either receive an SSB or transmit a RACH message during an RO or PO. In some cases, this decision may be up to UE implementation (e.g., similar to HD-FDD). For example, if a UE 115 does not perform any measurements of an SSB, the UE may transmit a RACH message on an overlapping RO. Otherwise, the UE 115 may perform the measurements. Additionally, or alternatively, if there no random access triggering event is detected or present (e.g., detected by the UE 115), then the UE 115 may measure an overlapping SSB instead. Additionally, or alternatively, a UE 115 may prioritize SSB measurements regardless of additional signaling, or may prioritize RACH transmissions instead (e.g., to reduce an increase in RACH latency as UL-SB benefits to latency by allowing flexible RACH may be lessened in an SBFD slot which has an SSB). In some cases, the UE 115 may make a determination based on a type of RACH (e.g., PRACH) triggering event. For example, if a type of triggering event is a beam failure recovery (BFR) operation or an asynchronous transmission, then the UE 115 may prioritize RACH transmission on an RO or PO and may measure an overlapping SSB for other triggering events.

Additionally, or alternatively, the UE 115 may make a determination based on an SSB index. For example, the UE 115 may determine to ignore some SSB indexes and transmit RACH. In some cases, the UE 115 ignore SSBs and favor PRACH transmissions for SSB indexes corresponding to poor quality SSBs of a same cell (e.g., with a lower receive power than other SSBs) or to SSBs of other serving cells (e.g., neighboring cells). The UE 115 may also transmit RACH messages if an SSB index corresponds to another carrier in carrier aggregation (e.g., an SCell). Otherwise, for indexes associated with higher priority SSBs (e.g., higher receive power, PCell), the UE 115 may favor SSB measurements and omit RACH transmissions.

In some examples, rules may differ or be the same or different on a type of transmission occasion for different types of RACH (e.g., 2-Step RACH or 4-Step RACH), types of RACH transmissions (Msg1, Msg3, or MsgA) or types of transmission occasions (e.g., RO or PO). For example, for PO collisions in SBFD slots (e.g., MsgA or Msg3) with SSBs, collision handling rules may prioritize SSBs, while for RO collisions with SSBs, UE implementation may determine to favor SSBs or RACH transmissions.

In some cases, ROs and POs may be defined similarly or differently for 2-Step RACH. For example, in 2-Step RACH, an RO may be defined as time and frequency resources allocated for a MsgA preamble transmission while multiple two-step RACH UEs may share a same RO in transmitting MsgA preambles. In some cases, a different UE may select a different preamble sequence (e.g., associated with code domain multiplexing). Additionally, or alternatively, a PO may be defined as time and frequency resources allocated for MsgA PUSCH transmission, where to support asynchronous UL transmission in two-step RACH, a guard time and guard band may be configured for each PO to mitigate the inter-symbol interference (ISI) or inter-carrier interference (ICI). A PUSCH Resource Unit (PRU) may be defined as a PO and DMRS port or sequence used for a MsgA payload transmission. In some examples, in 2-Step RACH, determination of valid ROs may involve each consecutive number of N_preamble indexes from valid ROs in a PRACH slot to be mapped to a valid PO and an associated demodulation reference signal (DMRS) resource. Further, for SBFD or other formats, a PO may be valid if the PO does not overlap in time and frequency with any valid RO associated with either a Type-1 RACH procedure or a Type-2 RACH procedure.

In resource allocation for MsgA payloads, content and payload size of a MsgA may depend on use cases and link qualities. For example, RRC_IDLE/INACTIVE modes may involve unique UE identifiers, RRC requests, and relatively small data while RRC_CONNECTED modes may involve MAC-CEs and data from a user plane (UP) and a control plane (CP). Further, multiple PO formats may be supported to accommodate different use cases and coverage requirements. MsgA may in some cases involve a fixed resource allocation, or a dynamic resource allocation (e.g., as bursty traffic patterns may cause a fixed allocation to be inefficient for a given payload size due).

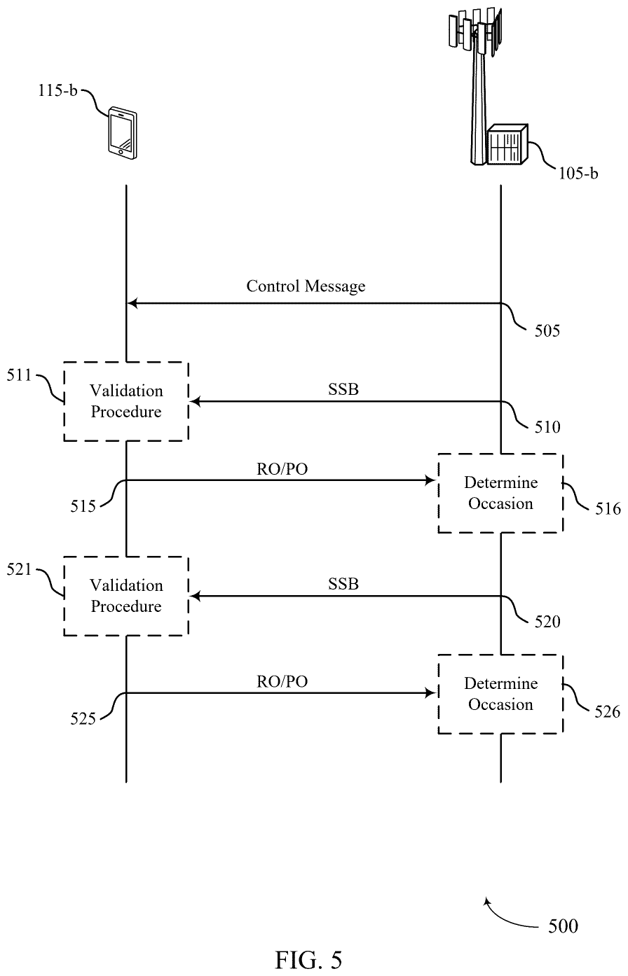

FIG. 5 shows an example of a process flow 500 that supports timing considerations for transmission occasions in full duplex in accordance with one or more aspects of the present disclosure. In some examples, the process flow 500 may implement or be implemented by aspects of the wireless communications systems 100 and 201, the timing diagrams 202, 301, and 302, or any combination thereof. For example, the process flow 500 may include one or more UEs 115, including a UE 115-b, and one or more network entities 105, including a network entity 105-b, that may support further improvements in communications by defining valid transmission occasions (e.g., ROs and POs) and timing considerations in full duplex communications (e.g., SBFD). In some cases, the network entity 105-b may support SBFD communications with multiple UEs 115 while the UE 115-b may support half-duplex communication.

In the following description of the process flow 500, the operations may be performed (such as reported or provided) in a different order than the order shown, or the operations performed by the example devices may be performed in different orders or at different times. Some operations also may be omitted from the process flow 500, or other operations may be added to the process flow 500. Further, although some operations or signaling may be shown to occur at different times for discussion purposes, these operations may actually occur at the same time or at least partially concurrently.

At 505, the UE 115-b may receive a control message (e.g., control message 245) indicating resources allocated for one or more random access messages associated with a random access procedure (e.g., one or more frequency or time resources of a common or two different RACH configurations). In some examples, the resources may include full duplex resources (e.g., SBFD resources) corresponding to one or more transmission occasions (e.g., transmission occasions 230) of the random access procedure.

At 510, the UE 115-b may receive, during a first time duration, a synchronization message (e.g., a synchronization message 235).

At 515, the UE 115-b may transmit a random access message associated with the random access procedure during a second time duration different from the first time duration, where the second time duration may be associated with a corresponding transmission occasion of the one or more transmission occasions. For example, at 515, the UE 115-b may transmit a Msg1, where the transmission occasion may be an RO and the random access procedure may be a 4-step random access procedure. Additionally, or alternatively, the UE 115-b may transmit a Msg3 or a MsgA, where the transmission occasion may be a PO and the random access procedure may be a 4-step random access procedure or a 2-step random access procedure. The first time duration corresponding to 510 (e.g., for SSBs) and the second time duration corresponding to 515 (e.g., for ROs/POs) may be in any order or configuration, where the first time duration may be before, after, adjacent to, or at least partially overlapping with the second time duration.

In some examples, the transmission of the random access message may be based on a validity of the transmission occasion, where the validity be based on relationship between the first time duration and the second time duration. For example, at 511, the UE 115-b may perform a validation procedure to determine the validity of the transmission occasion. The validation procedure may in some examples determine that the transmission occasion is valid based on one or more symbols of the second time duration preceding one or more symbols of the first time duration (e.g., a preceding condition is relaxed so RO/PO may precede SSB). In some cases, the UE 115-b may determine that the transmission occasion is valid based on a gap between the first time duration and the second time duration satisfying (e.g., >, ≥) a threshold time gap (e.g., N_{g}). In some examples, one or more symbols of the second time duration are within a same slot in the time domain as one or more symbols of the first time duration. Additionally, or alternatively, the UE 115-b may determine that the transmission occasion is valid based on a gap between the first time duration and the second time duration satisfying (e.g., >, ≥) a first threshold time gap that is less than a second threshold time gap (e.g., Ng) associated with a second random access procedure (e.g., N_{g} symbol gap is relaxed so RO/PO and SSB may be <Ng apart, adjacent, or even overlap). In some examples, the first threshold time gap may represent a quantity of symbols of a switching gap (e.g., a DL-UL switching gap including one or more symbols), where the transmission occasion may be valid if including at least a same quantity of symbols as the switching gap, and may be invalid if including less symbols than the switching gap.

Additionally, or alternatively, the UE 115-b may perform a validation procedure to determine that the transmission occasion is valid based on one or more symbols of the first time duration preceding one or more symbols of the second time duration and based on the gap between the first time duration and the second time duration satisfying the threshold time gap (e.g., no conditions are relaxed). In some examples, one or more symbols of the first time duration may overlap with one or more symbols of the second time duration. In some examples, the symbols of the first time duration may be determined as valid based on one or more symbols of the first time duration not overlapping with one or more symbols of the second time duration. Additionally, or alternatively, the synchronization message, the random access message, and the transmission occasion may be associated with a threshold frequency gap, two or more different beams, a threshold time gap for messages of a same index, a minimum transmission power for random access messages, or any combination thereof. In some examples, the UE 115-b may be in a connected mode or an idle mode, where the transmission occasion may be valid based on the UE 115-b being in an idle or connected mode. Additionally, or alternatively, transmission occasion may include one or more UL symbols or one or more flexible (e.g., FL) symbols in an UL-SB (e.g., e.g., at least one or more symbols of the transmission occasion are UL symbols or flexible symbols in an UL frequency sub-band, the transmission occasion is at least partially within SBFD symbols).

In some examples, the network entity 105-b may determine at 516 if the UE 115-b is able to transmit during the transmission occasion or able to receive the synchronization message, or may look for the transmission occasion based on one or more rules. The network entity 105-b may do so before or after one or more SSB or random access message transmissions, and one or more procedures may affect or be based on the determination of the network entity 105-b.

The UE 115-b may optionally receive one or more additional SSBs and transmit one or more additional random access messages during one or more random access occasions at 520 and 525. In some examples, at 521, the UE 115-b may perform another validation procedure to determine a validity of a second transmission occasion. For example, the second transmission occasion may involve an overlap between a second synchronization message to be received during a third time duration and a second random access message associated with a second random access procedure to be transmitted during a fourth time duration corresponding to the second transmission occasion, where one or more symbols of the third time duration may overlap with one or more symbols of the fourth time duration.

The second validation procedure may involve one or more collision handling rules, where the UE 115-b may determine to either receive the second synchronization message or to transmit the second random access message due to the overlap. For example, at 510, the UE 115-b may receive the second synchronization message during the third time duration based on one or more symbols of the third time duration overlapping with one or more symbols of the fourth time duration. In some examples, the UE 115-b may receive the second synchronization message based on the second synchronization message having a higher priority than the second transmission occasion, on performing one or more measurements for the second synchronization message, or on an index associated with the second synchronization message having a higher priority than one or more additional indexes, or any combination thereof.

By way of another example, the UE 115-b may determine to transmit the second random access message during the second validation procedure 521 and to refrain from receiving the overlapping second synchronization message. For example, the UE 115-b may transmit the second random access message during the fourth time duration corresponding to the second transmission occasion based on the overlap. In some examples, the UE 115-b may transmit the second random access message based on the second random access message and the second transmission occasion having a higher priority than the second synchronization message, on an occurrence of a random access triggering event, on the random access triggering event having a higher priority than one or more additional random access triggering events, or on the index associated with the second synchronization message having lower priority than the one or more additional indexes, or any combination thereof. Additionally, or alternatively, the network entity 105-b may determine at 526 if the UE 115-b is able to transmit during the second transmission occasion or able to receive the second synchronization message, or may look for the second transmission occasion based on one or more rules.

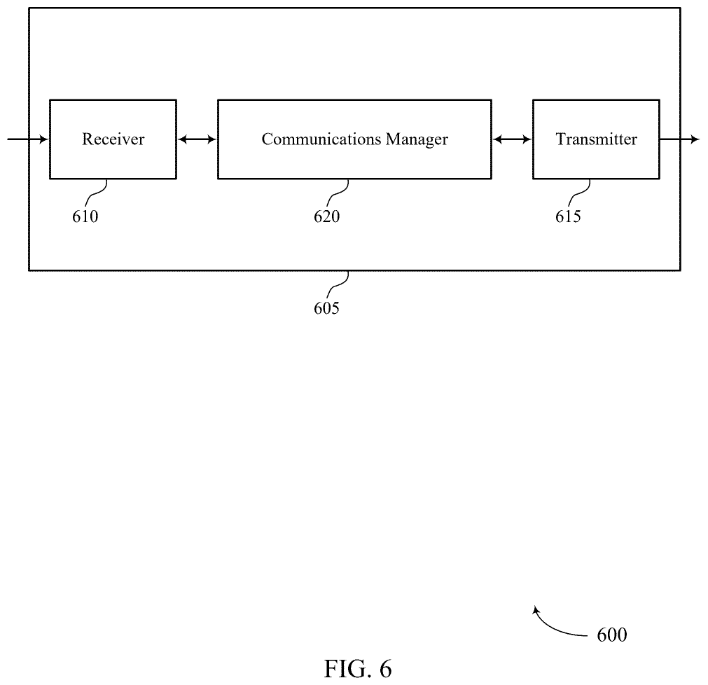

FIG. 6 shows a block diagram 600 of a device 605 that supports timing considerations for transmission occasions in full duplex in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to timing considerations for transmission occasions in full duplex). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to timing considerations for transmission occasions in full duplex). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of timing considerations for transmission occasions in full duplex as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. For example, the communications manager 620 is capable of, configured to, or operable to support a means for receiving a control message indicating resources allocated for one or more random access messages associated with a random access procedure, the resources including full duplex resources corresponding to one or more transmission occasions of the random access procedure. The communications manager 620 is capable of, configured to, or operable to support a means for receiving, during a first time duration, a synchronization message. The communications manager 620 is capable of, configured to, or operable to support a means for transmitting, during a second time duration different from the first time duration, a random access message associated with the random access procedure based on a validity of a transmission occasion, of the one or more transmission occasions, that corresponds to the second time duration, where the validity of the transmission occasion is based on a relationship between the first time duration and the second time duration.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced power consumption and more efficient utilization of communication resources (e.g., maximally utilizing one or more radio resources) by using a more flexible timing of communications, including reducing a symbol gap between ROs/POs and SSBs and allowing ROs/POs to precede one or more SSBs.

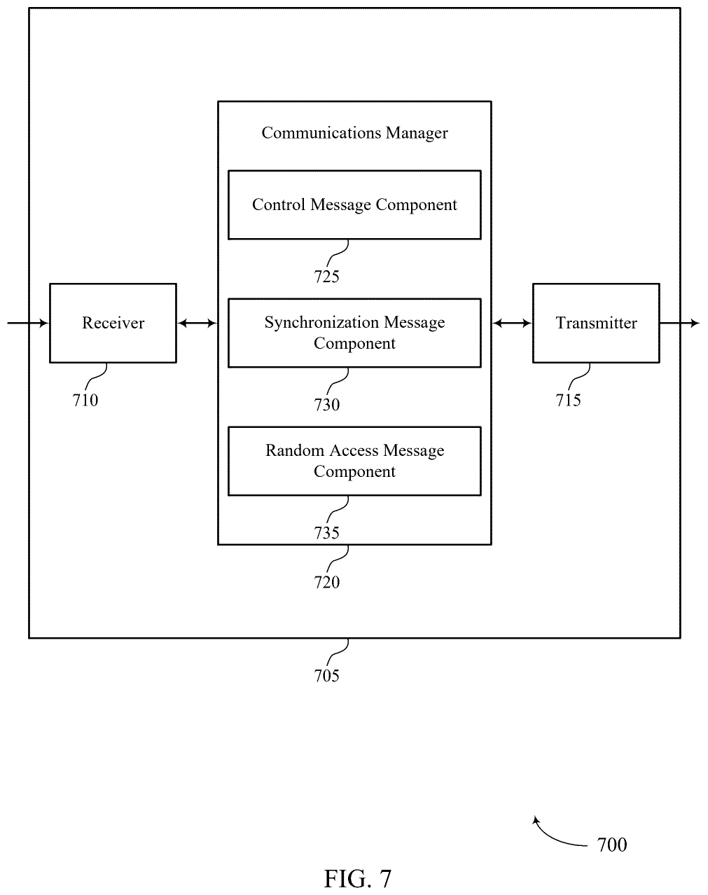

FIG. 7 shows a block diagram 700 of a device 705 that supports timing considerations for transmission occasions in full duplex in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to timing considerations for transmission occasions in full duplex). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to timing considerations for transmission occasions in full duplex). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of timing considerations for transmission occasions in full duplex as described herein. For example, the communications manager 720 may include a control message component 725, a synchronization message component 730, a random access message component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. The control message component 725 is capable of, configured to, or operable to support a means for receiving a control message indicating resources allocated for one or more random access messages associated with a random access procedure, the resources including full duplex resources corresponding to one or more transmission occasions of the random access procedure. The synchronization message component 730 is capable of, configured to, or operable to support a means for receiving, during a first time duration, a synchronization message. The random access message component 735 is capable of, configured to, or operable to support a means for transmitting, during a second time duration different from the first time duration, a random access message associated with the random access procedure based on a validity of a transmission occasion, of the one or more transmission occasions, that corresponds to the second time duration, where the validity of the transmission occasion is based on a relationship between the first time duration and the second time duration.

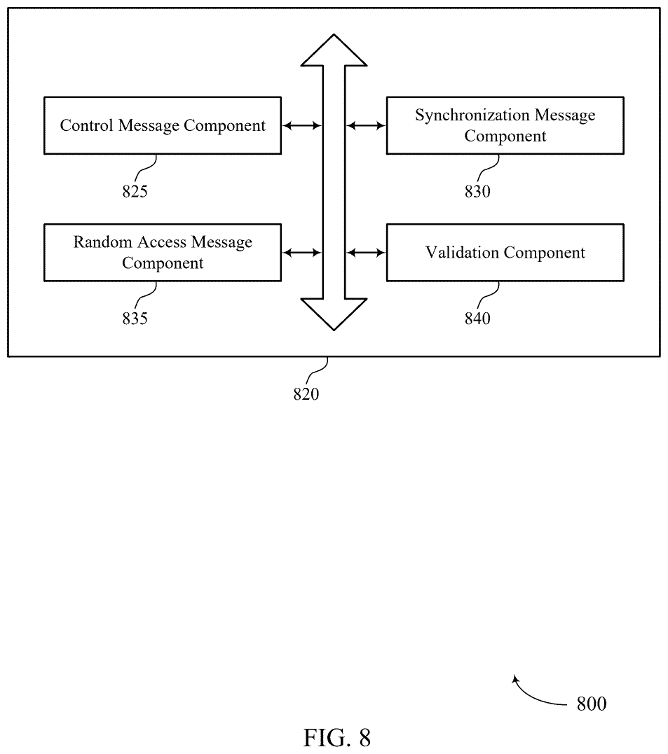

FIG. 8 shows a block diagram 800 of a communications manager 820 that supports timing considerations for transmission occasions in full duplex in accordance with one or more aspects of the present disclosure. The communications manager 820 may be an example of aspects of a communications manager 620, a communications manager 720, or both, as described herein. The communications manager 820, or various components thereof, may be an example of means for performing various aspects of timing considerations for transmission occasions in full duplex as described herein. For example, the communications manager 820 may include a control message component 825, a synchronization message component 830, a random access message component 835, a validation component 840, or any combination thereof. Each of these components, or components or subcomponents thereof (e.g., one or more processors, one or more memories), may communicate, directly or indirectly, with one another (e.g., via one or more buses).

The communications manager 820 may support wireless communication in accordance with examples as disclosed herein. The control message component 825 is capable of, configured to, or operable to support a means for receiving a control message indicating resources allocated for one or more random access messages associated with a random access procedure, the resources including full duplex resources corresponding to one or more transmission occasions of the random access procedure. The synchronization message component 830 is capable of, configured to, or operable to support a means for receiving, during a first time duration, a synchronization message. The random access message component 835 is capable of, configured to, or operable to support a means for transmitting, during a second time duration different from the first time duration, a random access message associated with the random access procedure based on a validity of a transmission occasion, of the one or more transmission occasions, that corresponds to the second time duration, where the validity of the transmission occasion is based on a relationship between the first time duration and the second time duration.

In some examples, the validation component 840 is capable of, configured to, or operable to support a means for performing a validation procedure to determine that the transmission occasion is valid based on one or more symbols of the second time duration preceding one or more symbols of the first time duration. In some examples, one or more symbols of the second time duration are within a same slot in the time domain as one or more symbols of the first time duration.

In some examples, the validation component 840 is capable of, configured to, or operable to support a means for performing a validation procedure to determine that the transmission occasion is valid based on a gap between the first time duration and the second time duration satisfying a first threshold time gap. In some examples, the validation component 840 is capable of, configured to, or operable to support a means for performing a validation procedure to determine that the transmission occasion is valid based on a gap between the first time duration and the second time duration satisfying a first threshold time gap that is less than a second threshold time gap associated with a second random access procedure.

In some examples, the validation component 840 is capable of, configured to, or operable to support a means for performing a validation procedure to determine that the transmission occasion is valid based on one or more symbols of the first time duration preceding one or more symbols of the second time duration and a gap between the first time duration and the second time duration satisfying a threshold time gap associated with a second random access procedure.

In some examples, the synchronization message component 830 is capable of, configured to, or operable to support a means for receiving, during a third time duration different from a fourth time duration corresponding to a second transmission occasion, a second synchronization message based one or more symbols of the third time duration overlapping with one or more symbols of the fourth time duration. In some examples, the random access message component 835 is capable of, configured to, or operable to support a means for transmitting, during the fourth time duration corresponding to the second transmission occasion, a second random access message associated with a second random access procedure based on the overlap.

In some examples, to support receiving the second synchronization message or transmitting the second random access message, the synchronization message component 830 is capable of, configured to, or operable to support a means for receiving the second synchronization message based on the second synchronization message having a higher priority than the second transmission occasion, on performing one or more measurements for the second synchronization message, or on an index associated with the second synchronization message having a higher priority than one or more additional indexes. In some examples, to support receiving the second synchronization message or transmitting the second random access message, the random access message component 835 is capable of, configured to, or operable to support a means for transmitting the second random access message based on the second random access message and the second transmission occasion having a higher priority than the second synchronization message, on an occurrence of a random access triggering event, on the random access triggering event having a higher priority than one or more additional random access triggering events, or on the index associated with the second synchronization message having lower priority than the one or more additional indexes.

In some examples, the validation component 840 is capable of, configured to, or operable to support a means for performing a validation procedure to determine that the transmission occasion is valid based on one or more symbols of the first time duration not overlapping with one or more symbols of the second time duration. In some examples, one or more symbols of the first time duration overlap with one or more symbols of the second time duration.

In some examples, the synchronization message, the random access message, and the transmission occasion are associated with a threshold frequency gap, two or more different beams, a threshold time gap for messages of a same index, and a minimum transmission power for random access messages, or any combination thereof.

In some examples, the UE is in a connected mode or an idle mode.

In some examples, the transmission occasion includes one or more UL symbols or one or more flexible (e.g., FL) symbols in an UL frequency sub-band. In some examples, the one or more UL symbols and the one or more flexible symbols include SBFD symbols (e.g., at least one or more symbols of the transmission occasion are UL symbols or flexible symbols in an UL frequency sub-band, the transmission occasion is at least partially within SBFD symbols).

In some examples, the transmission occasion includes a random access occasion and. In some examples, the random access procedure includes a 4 step random access procedure.

In some examples, the transmission occasion includes an PUSCH occasion and. In some examples, the random access procedure includes a 4 step random access procedure or a 2 step random access procedure.

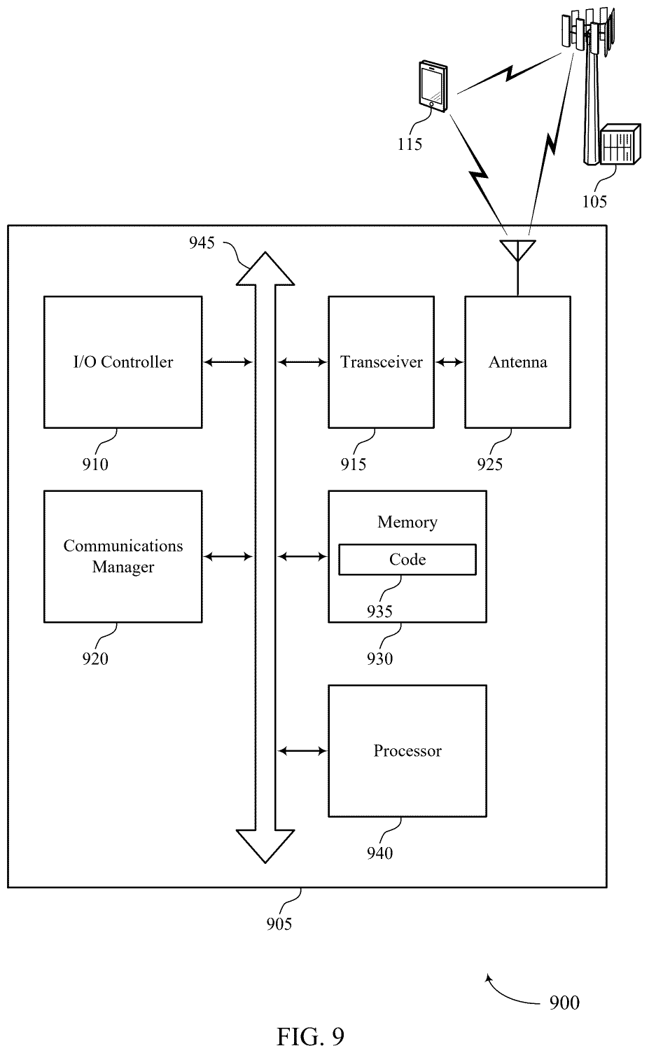

FIG. 9 shows a diagram of a system 900 including a device 905 that supports timing considerations for transmission occasions in full duplex in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting timing considerations for transmission occasions in full duplex). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communication in accordance with examples as disclosed herein. For example, the communications manager 920 is capable of, configured to, or operable to support a means for receiving a control message indicating resources allocated for one or more random access messages associated with a random access procedure, the resources including full duplex resources corresponding to one or more transmission occasions of the random access procedure. The communications manager 920 is capable of, configured to, or operable to support a means for receiving, during a first time duration, a synchronization message. The communications manager 920 is capable of, configured to, or operable to support a means for transmitting, during a second time duration different from the first time duration, a random access message associated with the random access procedure based on a validity of a transmission occasion, of the one or more transmission occasions, that corresponds to the second time duration, where the validity of the transmission occasion is based on a relationship between the first time duration and the second time duration.

By including or configuring the communications manager 920 in accordance with examples as described herein, the device 905 may support techniques for improved communication reliability, reduced latency, reduced power consumption, more efficient utilization of communication resources (e.g., maximally utilizing one or more radio resources), improved coordination between devices, and longer battery life by using a more flexible timing of communications, including reducing a symbol gap between ROs/POs and SSBs and allowing ROs/POs to precede one or more SSBs.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of timing considerations for transmission occasions in full duplex as described herein, or the at least one processor 940 and the at least one memory 930 may be otherwise configured to, individually or collectively, perform or support such operations.

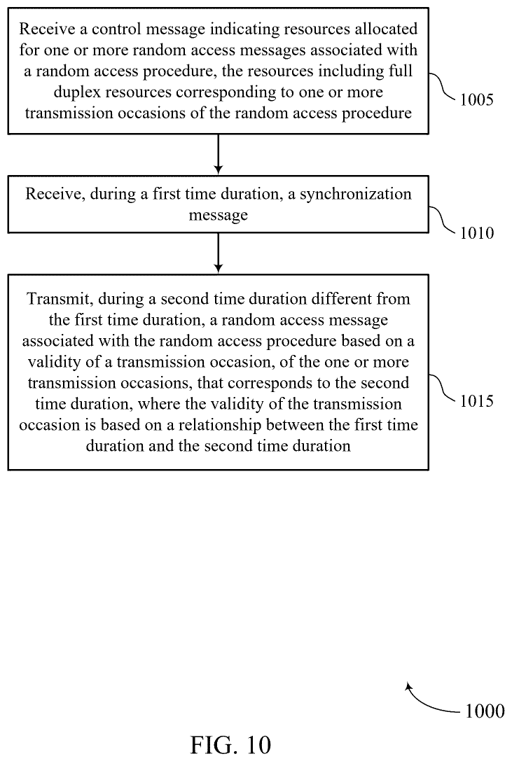

FIG. 10 shows a flowchart illustrating a method 1000 that supports timing considerations for transmission occasions in full duplex in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include receiving a control message indicating resources allocated for one or more random access messages associated with a random access procedure, the resources including full duplex resources corresponding to one or more transmission occasions of the random access procedure. The operations of 1005 may be performed in accordance with examples as disclosed herein. In some examples, aspects of the operations of 1005 may be performed by a control message component 825 as described with reference to FIG. 8.

At 1010, the method may include receiving, during a first time duration, a synchronization message. The operations of 1010 may be performed in accordance with examples as disclosed herein. In some examples, aspects of the operations of 1010 may be performed by a synchronization message component 830 as described with reference to FIG. 8.

At 1015, the method may include transmitting, during a second time duration different from the first time duration, a random access message associated with the random access procedure based on a validity of a transmission occasion, of the one or more transmission occasions, that corresponds to the second time duration, where the validity of the transmission occasion is based on a relationship between the first time duration and the second time duration. The operations of 1015 may be performed in accordance with examples as disclosed herein. In some examples, aspects of the operations of 1015 may be performed by a random access message component 835 as described with reference to FIG. 8.

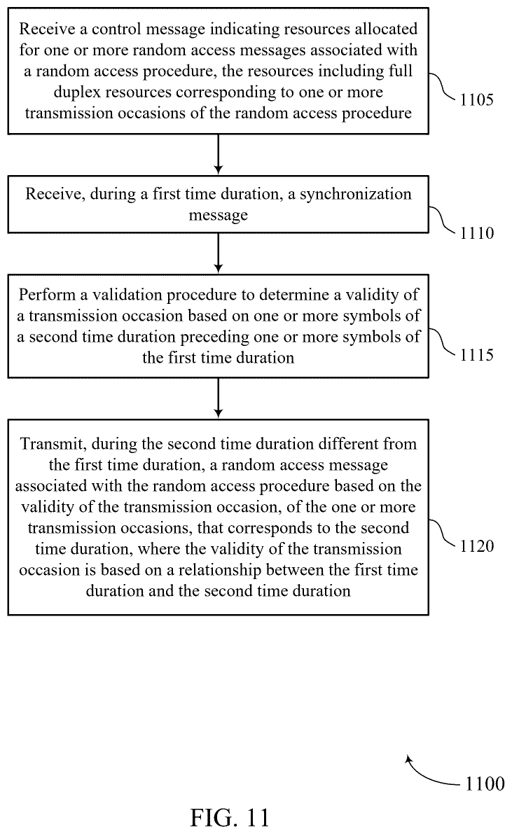

FIG. 11 shows a flowchart illustrating a method 1100 that supports timing considerations for transmission occasions in full duplex in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include receiving a control message indicating resources allocated for one or more random access messages associated with a random access procedure, the resources including full duplex resources corresponding to one or more transmission occasions of the random access procedure. The operations of 1105 may be performed in accordance with examples as disclosed herein. In some examples, aspects of the operations of 1105 may be performed by a control message component 825 as described with reference to FIG. 8.

At 1110, the method may include receiving, during a first time duration, a synchronization message. The operations of 1110 may be performed in accordance with examples as disclosed herein. In some examples, aspects of the operations of 1110 may be performed by a synchronization message component 830 as described with reference to FIG. 8.

At 1115, the method may include performing a validation procedure to determine a validity of a transmission occasion based on one or more symbols of a second time duration preceding one or more symbols of the first time duration. The operations of 1115 may be performed in accordance with examples as disclosed herein. In some examples, aspects of the operations of 1115 may be performed by a validation component 840 as described with reference to FIG. 8.

At 1120, the method may include transmitting, during the second time duration different from the first time duration, a random access message associated with the random access procedure based on the validity of the transmission occasion, of the one or more transmission occasions, that corresponds to the second time duration, where the validity of the transmission occasion is based on a relationship between the first time duration and the second time duration. The operations of 1120 may be performed in accordance with examples as disclosed herein. In some examples, aspects of the operations of 1120 may be performed by a random access message component 835 as described with reference to FIG. 8.

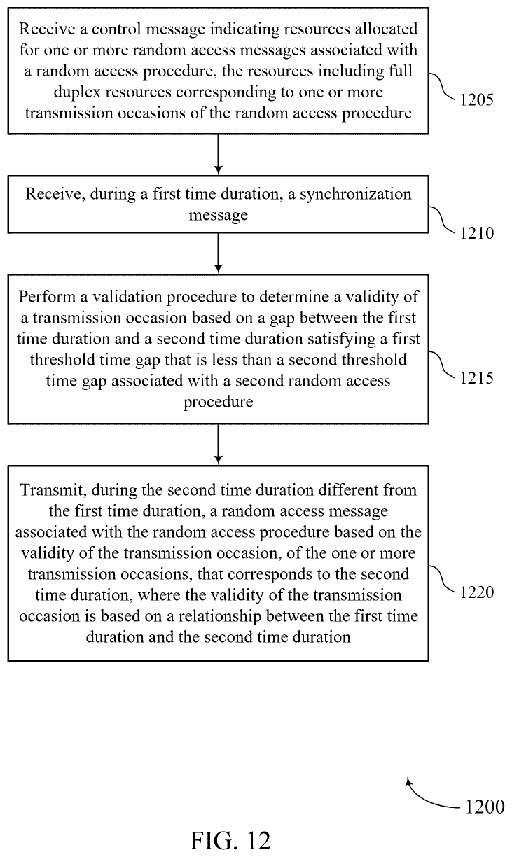

FIG. 12 shows a flowchart illustrating a method 1200 that supports timing considerations for transmission occasions in full duplex in accordance with one or more aspects of the present disclosure. The operations of the method 1200 may be implemented by a UE or its components as described herein. For example, the operations of the method 1200 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1205, the method may include receiving a control message indicating resources allocated for one or more random access messages associated with a random access procedure, the resources including full duplex resources corresponding to one or more transmission occasions of the random access procedure. The operations of 1205 may be performed in accordance with examples as disclosed herein. In some examples, aspects of the operations of 1205 may be performed by a control message component 825 as described with reference to FIG. 8.

At 1210, the method may include receiving, during a first time duration, a synchronization message. The operations of 1210 may be performed in accordance with examples as disclosed herein. In some examples, aspects of the operations of 1210 may be performed by a synchronization message component 830 as described with reference to FIG. 8.

At 1215, the method may include performing a validation procedure to determine a validity of a transmission occasion based on a gap between the first time duration and a second time duration satisfying a first threshold time gap that is less than a second threshold time gap associated with a second random access procedure. The operations of 1215 may be performed in accordance with examples as disclosed herein. In some examples, aspects of the operations of 1215 may be performed by a validation component 840 as described with reference to FIG. 8.

At 1220, the method may include transmitting, during the second time duration different from the first time duration, a random access message associated with the random access procedure based on the validity of the transmission occasion, of the one or more transmission occasions, that corresponds to the second time duration, where the validity of the transmission occasion is based on a relationship between the first time duration and the second time duration. The operations of 1220 may be performed in accordance with examples as disclosed herein. In some examples, aspects of the operations of 1220 may be performed by a random access message component 835 as described with reference to FIG. 8.

The following provides an overview of aspects of the present disclosure:

Aspect 1: A method for wireless communication by a UE, comprising: receiving a control message indicating resources allocated for one or more random access messages associated with a random access procedure, the resources comprising full duplex resources corresponding to one or more transmission occasions of the random access procedure; receiving, during a first time duration, a synchronization message; and transmitting, during a second time duration different from the first time duration, a random access message associated with the random access procedure based at least in part on a validity of a transmission occasion, of the one or more transmission occasions, that corresponds to the second time duration, wherein the validity of the transmission occasion is based at least in part on a relationship between the first time duration and the second time duration.

Aspect 2: The method of aspect 1, further comprising: performing a validation procedure to determine that the transmission occasion is valid based at least in part on one or more symbols of the second time duration preceding one or more symbols of the first time duration.

Aspect 3: The method of any of aspects 1 through 2, wherein one or more symbols of the second time duration are within a same slot in the time domain as one or more symbols of the first time duration.

Aspect 4: The method of any of aspects 1 through 3, further comprising: performing a validation procedure to determine that the transmission occasion is valid based at least in part on a gap between the first time duration and the second time duration satisfying a first threshold time gap.

Aspect 5: The method of any of aspects 1 through 4, further comprising: performing a validation procedure to determine that the transmission occasion is valid based at least in part on one or more symbols of the first time duration preceding one or more symbols of the second time duration and a gap between the first time duration and the second time duration satisfying a threshold time gap associated with a second random access procedure.

Aspect 6: The method of any of aspects 1 through 5, further comprising: receiving, during a third time duration different from a fourth time duration corresponding to a second transmission occasion, a second synchronization message based at least in part on one or more symbols of the third time duration overlapping with one or more symbols of the fourth time duration; or transmitting, during the fourth time duration corresponding to the second transmission occasion, a second random access message associated with a second random access procedure based at least in part on the overlap.

Aspect 7: The method of aspect 6, wherein receiving the second

synchronization message or transmitting the second random access message comprises: receiving the second synchronization message based at least in part on the second synchronization message having a higher priority than the second transmission occasion, on performing one or more measurements for the second synchronization message, or on an index associated with the second synchronization message having a higher priority than one or more additional indexes; or transmitting the second random access message based at least in part on the second random access message and the second transmission occasion having a higher priority than the second synchronization message, on an occurrence of a random access triggering event, on the random access triggering event having a higher priority than one or more additional random access triggering events, or on the index associated with the second synchronization message having lower priority than the one or more additional indexes.

Aspect 8: The method of any of aspects 1 through 7, further comprising: performing a validation procedure to determine that the transmission occasion is valid based at least in part on one or more symbols of the first time duration not overlapping with one or more symbols of the second time duration.

Aspect 9: The method of any of aspects 1 through 8, wherein the synchronization message, the random access message, and the transmission occasion are associated with a threshold frequency gap, two or more different beams, a threshold time gap for messages of a same index, and a minimum transmission power for random access messages, or any combination thereof.

Aspect 10: The method of any of aspects 1 through 9, wherein the UE is in a connected mode or an idle mode.

Aspect 11: The method of any of aspects 1 through 10, wherein the transmission occasion comprises one or more UL symbols or one or more flexible symbols in an UL frequency sub-band, wherein the one or more UL symbols and the one or more flexible symbols comprise SBFD symbols.

Aspect 12: The method of any of aspects 1 through 11, wherein the transmission occasion comprises an RO, and the random access procedure comprises a 4 step random access procedure.

Aspect 13: The method of any of aspects 1 through 11, wherein the transmission occasion comprises a PO, and the random access procedure comprises a 4 step random access procedure or a 2 step random access procedure.

Aspect 14: A UE for wireless communication, comprising one or more memories storing processor-executable code, and one or more processors coupled with the one or more memories and individually or collectively operable to execute the code to cause the UE to perform a method of any of aspects 1 through 13.

Aspect 15: A UE for wireless communication, comprising at least one means for performing a method of any of aspects 1 through 13.

Aspect 16: A non-transitory computer-readable medium storing code for wireless communication, the code comprising instructions executable by one or more processors to perform a method of any of aspects 1 through 13.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a control message indicating resources allocated for one or more random access messages associated with a random access procedure, the resources comprising full duplex resources corresponding to one or more transmission occasions of the random access procedure;
receive, during a first time duration, a synchronization message; and
transmit, during a second time duration different from the first time duration, a random access message associated with the random access procedure based at least in part on a validity of a transmission occasion, of the one or more transmission occasions, that corresponds to the second time duration, wherein the validity of the transmission occasion is based at least in part on a relationship between the first time duration and the second time duration.

2. The UE of claim 1, wherein the one or more processors are individually or collectively further operable to execute the code to cause the UE to:
perform a validation procedure to determine that the transmission occasion is valid based at least in part on one or more symbols of the second time duration preceding one or more symbols of the first time duration.

3. The UE of claim 2, wherein one or more symbols of the second time duration are within a same slot in the time domain as one or more symbols of the first time duration.

4. The UE of claim 1, wherein the one or more processors are individually or collectively further operable to execute the code to cause the UE to:
perform a validation procedure to determine that the transmission occasion is valid based at least in part on a gap between the first time duration and the second time duration satisfying a first threshold time gap.

5. The UE of claim 1, wherein the one or more processors are individually or collectively further operable to execute the code to cause the UE to:
perform a validation procedure to determine that the transmission occasion is valid based at least in part on one or more symbols of the first time duration preceding one or more symbols of the second time duration and a gap between the first time duration and the second time duration satisfying a threshold time gap associated with a second random access procedure.

6. The UE of claim 1, wherein the one or more processors are individually or collectively further operable to execute the code to cause the UE to:
receive, during a third time duration different from a fourth time duration corresponding to a second transmission occasion, a second synchronization message based at least in part on one or more symbols of the third time duration overlapping with one or more symbols of the fourth time duration; or
transmit, during the fourth time duration corresponding to the second transmission occasion, a second random access message associated with a second random access procedure based at least in part on the overlap.

7. The UE of claim 6, wherein, to receive the second synchronization message or to transmit the second random access message, the one or more processors are individually or collectively operable to execute the code to cause the UE to:
receive the second synchronization message based at least in part on the second synchronization message having a higher priority than the second transmission occasion, on performing one or more measurements for the second synchronization message, or on an index associated with the second synchronization message having a higher priority than one or more additional indexes; or
transmit the second random access message based at least in part on the second random access message and the second transmission occasion having a higher priority than the second synchronization message, on an occurrence of a random access triggering event, on the random access triggering event having a higher priority than one or more additional random access triggering events, or on the index associated with the second synchronization message having lower priority than the one or more additional indexes.

8. The UE of claim 1, wherein the one or more processors are individually or collectively further operable to execute the code to cause the UE to:
perform a validation procedure to determine that the transmission occasion is valid based at least in part on one or more symbols of the first time duration not overlapping with one or more symbols of the second time duration.

9. The UE of claim 1, wherein the synchronization message, the random access message, and the transmission occasion are associated with a threshold frequency gap, two or more different beams, a threshold time gap for messages of a same index, and a minimum transmission power for random access messages, or any combination thereof.

10. The UE of claim 1, wherein the UE is in a connected mode or an idle mode.

11. The UE of claim 1, wherein the transmission occasion comprises one or more uplink symbols or one or more flexible symbols in an uplink frequency sub-band, wherein the one or more uplink symbols and the one or more flexible symbols comprise sub-band full duplex symbols.

12. The UE of claim 1, wherein:
the transmission occasion comprises a random access occasion, and
the random access procedure comprises a 4 step random access procedure.

13. The UE of claim 1, wherein:
the transmission occasion comprises a physical uplink shared channel (PUSCH) occasion, and
the random access procedure comprises a 4 step random access procedure or a 2 step random access procedure.

14. A method for wireless communication by a user equipment (UE), comprising:
receiving a control message indicating resources allocated for one or more random access messages associated with a random access procedure, the resources comprising full duplex resources corresponding to one or more transmission occasions of the random access procedure;
receiving, during a first time duration, a synchronization message; and
transmitting, during a second time duration different from the first time duration, a random access message associated with the random access procedure based at least in part on a validity of a transmission occasion, of the one or more transmission occasions, that corresponds to the second time duration, wherein the validity of the transmission occasion is based at least in part on a relationship between the first time duration and the second time duration.

15. The method of claim 14, further comprising:
performing a validation procedure to determine that the transmission occasion is valid based at least in part on one or more symbols of the second time duration preceding one or more symbols of the first time duration.

16. The method of claim 15, wherein one or more symbols of the second time duration are within a same slot in the time domain as one or more symbols of the first time duration.

17. The method of claim 14, further comprising:
performing a validation procedure to determine that the transmission occasion is valid based at least in part on a gap between the first time duration and the second time duration satisfying a first threshold time gap.

18. A non-transitory computer-readable medium storing code for wireless communication, the code comprising instructions executable by one or more processors to:
receive a control message indicating resources allocated for one or more random access messages associated with a random access procedure, the resources comprising full duplex resources corresponding to one or more transmission occasions of the random access procedure;
receive, during a first time duration, a synchronization message; and
transmit, during a second time duration different from the first time duration, a random access message associated with the random access procedure based at least in part on a validity of a transmission occasion, of the one or more transmission occasions, that corresponds to the second time duration, wherein the validity of the transmission occasion is based at least in part on a relationship between the first time duration and the second time duration.

19. The non-transitory computer-readable medium of claim 18, wherein the instructions are further executable by the one or more processors to:
perform a validation procedure to determine that the transmission occasion is valid based at least in part on one or more symbols of the second time duration preceding one or more symbols of the first time duration.

20. The non-transitory computer-readable medium of claim 19, wherein one or more symbols of the second time duration are within a same slot in the time domain as one or more symbols of the first time duration.
